(19) United States
(12) Patent Application Publication
(10) Pub. No.: US 2013/0248188 A1
(43) Pub. Date: Sep. 26, 2013

(54) IN-SITU SELF DIVERTING WAG PROCESS

(71) Applicant: SAUDI ARABIAN OIL COMPANY, Dhahran (SA)

(72) Inventors: Fawaz M. Al-Otaibi, Dhahran (SA); Sunil Kokal, Dhahran (SA); Mohammed H. Al-Khaldi, Dhahran (SA); Mohammed G. Faifi, Dhahran (SA)

(73) Assignee: Saudi Arabian Oil Company, Dhahran (SA)

(21) Appl. No.: 13/848,935

(22) Filed: Mar. 22, 2013

Related U.S. Application Data
(60) Provisional application No. 61/614,821, filed on Mar. 23, 2012.

(51) Int. Cl. C09K 8/84; E21B 43/16

(52) U.S. Cl. CPC C09K 8/845; E21B 43/166
USPC 166/305.1; 507/277

(57) ABSTRACT

An aqueous viscoelastic solution for use in a modified water alternating gas (WAG) hydrocarbon production method includes a viscoelastic surfactant and a salt in an aqueous base solution. A modified water alternating gas (WAG) method for producing hydrocarbons from a hydrocarbon-bearing formation includes the step of introducing the aqueous viscoelastic solution into the hydrocarbon-bearing formation. The method also includes the step of introducing a service gas into the hydrocarbon-bearing formation. The aqueous viscoelastic solution and the service gas are introduced separately and sequentially into the hydrocarbon-bearing formation. The hydrocarbon-bearing formation produces a production fluid in response to each introduction. The production fluid contains both water and hydrocarbons.

### CROSS-REFERENCE TO RELATED PATENT APPLICATIONS

This application claims priority from U.S. Provisional Application No. 61/614,821, filed Mar. 23, 2012. For purposes of United States patent practice, this application incorporates the contents of the Provisional Application by reference in its entirety.

### BACKGROUND OF THE INVENTION

1. Field of the Invention

The field of invention relates to the recovery of hydrocarbons from subterraneous formations. Specifically, the field of invention relates to enhanced oil recovery (EOR).

2. Description of the Related Art

“Primary recovery” is the recovery of hydrocarbons through the natural flow or artificial lift of the energy already present in the hydrocarbon reservoir. Primary recovery does not add or introduce energy into the formation.

Upon depletion of the energy present in a reservoir, the rate of recovery declines. An operator can increase the production from the formation by adding to the amount of energy present in the hydrocarbon reservoir to drive fluids to the surface. “Secondary recovery” is the recovery of hydrocarbons that involves the introduction of artificial energy into the hydrocarbon reservoir. Examples include injecting hydrocarbons from a first well into a second well, which increases the energy in the portion of the reservoir associated with the second well. Conventional means of secondary recovery include the immiscible processes of water injection (“water flooding”) and pressurized gas injection (“gas flooding”). These techniques not only boost formation pressure but also physically act upon the hydrocarbons present by pushing them through the formation from the injection point to the extraction point.

After secondary recovery, a substantial amount of hydrocarbons, especially the more viscous parts of crude oil, remain in the reservoir. In addition, trapped oil exists in parts of the reservoir that primary or secondary recovery techniques can never extract, “Tertiary recovery” drives the remaining hydrocarbons to the surface by changing the properties of the produced hydrocarbon fluid.

Enhanced oil recovery (EOR) uses chemicals to recover crude oil not freed by primary or secondary techniques. In some instances, EOR can extract residual hydrocarbons without using gas or water flooding before treatment.

Injecting a gas into a hydrocarbon-bearing formation can have several effects. Gas injected after primary recovery can increase the pressure of the formation, which can motivate already mobile hydrocarbons and permit additional recovery. Gases flooding the formation can carry fluids and drive hydrocarbons toward the extraction point. Gases can also solvate or modify the chemical or physical properties of the hydrocarbons, releasing trapped, viscous or otherwise immobile hydrocarbons from the formation. Many secondary, tertiary and EOR processes use gases either in single injections, in combination with one another or with liquids to extract hydrocarbons.

Two problems exist with direct application of a sweeping or treatment fluid: viscous fingering and gravity override. “Viscous fingering” demonstrates the viscosity differential between the sweeping/treatment fluid and the hydrocarbons in the formation. The lower viscosity, highly mobile sweeping/treatment fluid can push through higher viscosity, less mobile fluid hydrocarbons. This creates channels in the formation that convey a significant portion of the trailing sweeping/treatment fluid directly to the extraction wells. The result is premature sweeping/treatment fluid breakthrough and reduced hydrocarbon recovery that degrades efficiency. “Gravity override” is the effect of buoyancy on gases and liquids. After injection, gases tend to migrate upwards in a contiguous formation and liquids tend to migrate downwards. Such vertical displacements in horizontal or angular formations between injection and extraction wells can result in ineffective exposure of parts of the formation to the sweeping/treatment fluid.

Continuous fluid injection, water alternating gas (WAG), tapered gas injection and co-injection (liquid saturated vapor and gas saturated liquid) mitigate some of these fluid interaction effects.

Traditional WAG processes involve alternating injections of an aqueous fluid, including water, brines and filtered seawater, and a sweeping or treatment gas, including carbon dioxide, nitrogen or natural gas. The number and length of “slugs” or cycles between introducing gas and liquid can vary depending on many technical and economic factors of producing from an oil-bearing formation. Sandwiching injected liquids and gases between one another reduces the undesirable mobility issues while maintaining the overall desirable attribute of sweeping through the formation.

WAG processes are ineffective under certain reservoir conditions. In heterogeneous, multi-layered reservoirs, which can contain streaks of highly permeable stratum, fractures, “thief zones” or hydrocarbon-bearing strata with contrasting permeability in communication with one another, most of the injected fluids channel through zones that permit greater fluid mobility. Injected fluids preferentially follow these permeable layers even when using a WAG process due to their low viscosity and surface tension.

### SUMMARY OF THE INVENTION

An aqueous viscoelastic solution for use in a modified water alternating gas (WAG) hydrocarbon production method includes a viscoelastic surfactant and a salt in an aqueous base solution.

A modified water alternating gas (WAG) method for producing hydrocarbons from a hydrocarbon-bearing formation includes the step of introducing the aqueous viscoelastic solution into the formation. The method also includes the step of introducing a service gas into the formation. The introduction of the aqueous viscoelastic solution and the service gas into the formation is separate and sequential. The hydrocarbon-bearing formation produces a production fluid in response to each introduction. The production fluid contains both water and hydrocarbons.

A method for producing hydrocarbons from a hydrocarbon-bearing heterogeneous formation includes the step of introducing a sweeping fluid into the hydrocarbon-bearing heterogeneous formation. The hydrocarbon-bearing heterogeneous formation has a low permeability stratum and a high permeability stratum. The method also includes the step of introducing an aqueous viscoelastic solution into the formation. The method also includes the step of introducing a service gas into the formation. The introduction of sweeping fluid occurs before either the aqueous viscoelastic solution or the service gas. The introduction of each fluid into the formation is separate and sequential. The hydrocarbon-bearing formation produces a production fluid in response to each introduction. The production fluid contains both sweeping fluid and hydrocarbons.

The modified WAG method uses a service gas and an aqueous viscoelastic solution. The method introduces the service gas and the aqueous viscoelastic solution into the heterogeneous formation in an alternating, cyclical fashion. A single cycle of the modified WAG method includes introduction of the service gas and introduction of the aqueous viscoelastic solution. The order of introduction can vary based upon formation conditions and operator preference.

The aqueous viscoelastic solution exhibits self-diverting behavior through changes in bulk viscosity based upon the presence or absence of hydrocarbons. This change in viscosity causes channeling of treatment fluids to areas of the reservoir where hydrocarbons are in varied geological structures. The channeling prevents viscous fingering and gravity override by diverting treatment fluids towards the areas containing hydrocarbons and not permitting flow based upon previously formed fluid channels or gravity. Sweeping treatments are more effective using the aqueous viscoelastic solution.

Use of the modified WAG method can occur under widely varying conditions. The modified WAG method is effective in treating formations with multiple hydrocarbon-bearing strata, and especially in heterogeneous formations. Heterogeneous formations often have adjacent stratum of low permeability and high permeability, including gaps and fractures, and at least some highly viscous or hydrocarbons trapped in “tight” formations remain after primary recovery.

### BRIEF DESCRIPTION OF THE DRAWINGS

These and other features, aspects, and advantages of the present invention are better understood with regard to the following Detailed Description of the Preferred Embodiments, appended Claims, and accompanying Figures, where:

FIG. 1 shows graphically the results of the Comparative Example method on the set of tandem core samples, and

FIG. 2 shows graphically the results of the Example method on the set of tandem core samples.

### DETAILED DESCRIPTION OF THE PREFERRED EMBODIMENTS

The Specification, which includes the Summary of Invention, Brief Description of the Drawings and the Detailed Description of the Preferred Embodiments, and the appended Claims refer to particular features (including process or method steps) of the invention. Those of skill in the art understand that the invention includes all possible combinations and uses of particular features described in the Specification. Those of skill in the art understand that the invention is not limited to or by the description of embodiments given in the Specification. The inventive subject matter is not restricted except only in the spirit of the Specification and appended Claims.

Those of skill in the art also understand that the terminology used for describing particular embodiments does not limit the scope or breadth of the invention. In interpreting the Specification and appended Claims, all terms should be interpreted in the broadest possible manner consistent with the context of each term. All technical and scientific terms used in the Specification and appended Claims have the same meaning as commonly understood by one of ordinary skill in the art to which this invention belongs unless defined otherwise.

As used in the Specification and appended Claims, the singular forms “a”, “an”, and “the” include plural references unless the context clearly indicates otherwise. The verb “comprises” and its conjugated forms should be interpreted as referring to elements, components or steps in a non-exclusive manner. The referenced elements, components or steps may be present, utilized or combined with other elements, components or steps not expressly referenced. The verb “couple” and its conjugated forms means to complete any type of required junction, including electrical, mechanical or fluid, to form a singular object from two or more previously non-joined objects, if a first device couples to a second device, the connection can occur either directly or through a common connector. “Optionally” and its various forms means that the subsequently described event or circumstance may or may not occur. The description includes instances where the event or circumstance occurs and instances where it does not occur. “Operable” and its various forms means fit for its proper functioning and able to be used for its intended use. “Associated” and its various forms means something connected with something else because they occur together or that one produces the other.

Spatial terms describe the relative position of an object or a group of objects relative to another object or group of objects. The spatial relationships apply along vertical and horizontal axes. Orientation and relational words including “upwards” and “downwards” and other like terms are for descriptive convenience and are not limiting unless otherwise indicated.

Where the Specification or the appended Claims provide a range of values, it is understood that the interval encompasses each intervening value between the upper limit and the lower limit as well as the upper limit and the lower limit. The invention encompasses and bounds smaller ranges of the interval subject to any specific exclusion provided. “Substantially free” means less than 1% by the indicated unit of measure.

Where the Specification and appended Claims reference a method comprising two or more defined steps, the defined steps can be carried out in any order or simultaneously except where the context excludes that possibility.

### Service Gas

The modified WAG method uses a service gas. Useful service gases include air, nitrogen, flue gases (a combination of nitrogen, carbon monoxide and carbon dioxide), carbon dioxide, steam and hydrocarbon gases, including purified fractions and unrefined compositions. The level of service gas miscibility with the hydrocarbons in the hydrocarbon-bearing formation can vary depends on the manner of introduction and conditions within the formation.

Carbon dioxide is useful as a service gas. Carbon dioxide interacts with crude oil in such a way as to affect its physical properties. Crude oil swells in volume as it absorbs carbon dioxide, lowering its fluid viscosity and freeing it from tighter formations having relatively inaccessible pores. Carbon dioxide also is operable to extract lighter hydrocarbons out of heavier hydrocarbon phases and transport the lighter hydrocarbons towards a point of extraction.

Introduced carbon dioxide can take the form of a gas, liquid or supercritical fluid. Useful carbon dioxide has a concentration greater than about 95 mole %.

### Aqueous Viscoelastic Solution

The aqueous viscoelastic solution includes a viscoelastic surfactant and a salt in a base aqueous solution. The aqueous viscoelastic solution has a water-like viscosity when it is in contact with hydrocarbons; otherwise, it has a gel-like viscosity. The shifting viscosity based upon the presence or lack thereof of hydrocarbons makes the aqueous viscoelastic solution operable to direct other fluids, including service gases, preferentially towards portions of the formation heaving hydrocarbons. The aqueous viscoelastic solution has a pH value of 3 or greater.

### Base Aqueous Solution

Deionized, tap and fresh waters; unsaturated, brackish, natural, saturated and super-saturated salt waters; natural, salt dome, petroleum production byproduct and synthetic brines; seawater; mineral waters; and other potable and non-potable waters containing one or more dissolved salts, minerals or organics are useful as the base aqueous solution for the aqueous viscoelastic solutions.

### Viscoelastic Surfactant

The aqueous viscoelastic solution includes a viscoelastic surfactant. Useful viscoelastic surfactants include non-ionic and ionic, and combination of the two types. The molecules of the viscoelastic surfactants tend to aggregate and form micelle-like structures when not in the presence of hydrocarbons. Although not intending to be bound by theory, it is believed that the surfactant micelles structures form a network of similar long-length molecules. The network of micelles causes the viscosity of the aqueous viscoelastic solutions to be greater than water when not in the presence of hydrocarbons and to be comparable to that of water when in the presence of hydrocarbons.

Non-ionic viscoelastic surfactants are surface-active agents that do not dissociate into ions in aqueous solution. Useful non-ionic surfactants are compatible with other ionic and non-ionic components of embodiments of the aqueous viscoelastic solution. The hydrophilic functional group on the non-ionic surfactant can include alcohols, phenols, ethers, esters and amides. Examples of useful non-ionic viscoelastic surfactant include ethoxylated normal, iso- and cyclo-alkyl alcohols; ethoxylated phenols; ethoxylated alkyl phenols such as octyl, nonyl and dodecyl-alkyl phenols; various epoxide block co-polymerizations of ethylene oxide with other alkoxylates, including propylene oxide and butylene oxide; and fatty alcohols.

Ionic viscoelastic surfactants have an electrochemically charged hydrophilic head, an electrochemically neutral hydrophobic tail and an electrochemically charged counter ion that is either organic or inorganic associated with the hydrophilic head. The hydrophobic tail, which is the portion that interacts with the hydrocarbons, can be fully or partially saturated, linear or branched, and is a hydrocarbon chain that is generally limited in length only by the mobility and solubility requirements of the surfactant in the aqueous viscoelastic solution. Ionic viscoelastic surfactants include anionic or cationic surfactants.

When the viscoelastic surfactant is anionic, it is associated with a positive counter ion. Positive counter ions can be inorganic or organic. Sodium and potassium form positive ions, and calcium and magnesium form positive divalent ions, inorganic positive counter ions can originate from alkali metals, alkaline earth metals, and transition metal groups of the Periodic Table of Elements. Examples of useful anionic viscoelastic surfactants include certain alkyl sulfates, alkyl ether sulfates, alkyl ester sulfonates, alpha olefin sulfonates, linear alkyl benzene sultanates, branched alkyl benzene sulfonates, alkyl benzene sulfonic acids, sulfosuccinates, sulfated alcohols, alkoxylated sulfated alcohols, alcohol sultanates, alkoxylated alcohol sultanates, alcohol ether sulfates, and alkoxylated alcohol ether sulfates.

When the viscoelastic surfactant is cationic, it is associated with a negative counter ion. Negative counter ions can be inorganic or organic. Inorganic counter ions include sulfates, nitrates, perchlorates and halides, including chlorides and bromides. Organic counter ions include salicylates such as aromatic salicylate; naphthalene sulfonates; chlorobenzoates; dichlorobenzoates; t-butyl and ethyl phenate; and di-, tri- and tetra-chlorophenates. Example of useful cationic viscoelastic surfactants include erucyl bis(hydroxyethyl) methyl ammonium chloride (MAC); tributyl hexadecyl phosphonium bromide; trioctyl methyl ammonium chloride; cetyl trimethyl ammonium salicylate (CTASal); erucyl trimethyl ammonium chloride (ETAC); oleyl methyl bis(hydroxyethyl) ammonium chloride; erucyl amidopropyl trimethylamine chloride; octadecyl methyl bis(hydroxyethyl) ammonium bromide; octadecyl tris(hydroxyethyl) ammonium bromide; and octadecyl dimethyl hydroxyethyl ammonium bromide.

### Salt

The aqueous viscoelastic solution includes a salt. The salt is water-soluble, either an inorganic or organic salt, and can include a combination of both types. Examples of useful inorganic salts include potassium chloride, ammonium chloride, sodium chloride, calcium chloride, magnesium chloride, and sodium isocyanate. Examples of useful organic salts include sodium salicylate, salts of uric acid and potassium tartrates.

Salts can originate with the base aqueous solution. For example, filter seawater can contain salts that ionize into magnesium, manganese, potassium, strontium, sodium, calcium, aluminum, zinc, silicon, lithium, chromium, iron, copper, and phosphorus salts of halides, carbonates, chlorates, bromates, formats, nitrates, oxides, sulfates, nitrates and cyanates. The base aqueous solution can supply part of or all of the salt for the aqueous viscoelastic solutions.

### Forming Aqueous Viscoelastic Solutions

The aqueous viscoelastic solution can contain one or more viscoelastic surfactant. Viscoelastic surfactants are present in the aqueous viscoelastic solutions in a range of from about 0.1 weight percent to about 6 weight percent as a percentage of the total weight of the aqueous viscoelastic solution.

The aqueous viscoelastic solution can contain one or more salt. Salts are present in the aqueous viscoelastic solutions in a range of from about 1 weight percent to about 10 weight percent as a percentage of the total weight of the aqueous viscoelastic solutions.

The exact quantity of and kind of base aqueous solution, viscoelastic surfactant and salt used in the aqueous viscoelastic solution varies on desired properties in the hydrocarbon-bearing formation environment. Laboratory and field tests are useful in determining the appropriate amount of components of the aqueous viscoelastic solution composition.

Combining the components in any order prepares the aqueous viscoelastic solution. An example for discussion purposes includes combining in a vessel that is operable to retain the combination of components an amount of base aqueous solution, a salt and a viscoelastic surfactant. A useful blending means, including a low- or high-shear blending mixer or a paddle, mixes the combination together until an intimate mixture forms.

Upon formation of the mixture, the aqueous viscoelastic solution exhibits the viscoelastic response. The aqueous viscoelastic solutions demonstrate a significant difference in fluid viscosity and solution behavior depending on the presence or lack thereof of hydrocarbons. This behavior change is due to the nature of the viscoelastic surfactant, the ionic species and the presence of hydrocarbons (or lack thereof) in solution. When not in the presence of a hydrocarbon, the viscosity of the aqueous viscoelastic solution is greater than when hydrocarbons are present. The aqueous viscoelastic solution has a viscosity that is greater than 2 centiPoise (cP). When hydrocarbons are present, the viscosity of the aqueous viscoelastic solution approaches that of the viscosity of water, or about 1 cP. Although not intending to be bound by theory, it is believed that the viscoelastic surfactant molecules organize themselves into non-spherical micelles. When the micelles possess an elongated configuration, including rod-shaped or worm-shaped, the micelles entangle with one another. The entanglement of the hydrophobic portion of the viscoelastic molecule is similar to the entanglement seen in polymer solutions. Entanglement restricts three-dimensional fluid movement and results in increased fluid viscosity.

Aqueous viscoelastic solutions are sensitive to the presence of hydrocarbons. The tenuous network of micelles formed by the surfactants breaks down in the presence of hydrocarbons such as those remaining in the formation after primary treatment. The viscoelastic surfactant chemically interacts with hydrocarbons present in the formation renders them mobile. The aqueous viscoelastic solution acts as surfactant-laden aqueous solutions when in the presence of hydrocarbons, operable to dissolve hydrocarbons into the aqueous viscoelastic solution. The viscoelastic surfactants lower the interfacial tension between the crude oil in the hydrocarbon-bearing formation and the base aqueous solution of the aqueous viscoelastic solution. The viscoelastic surfactants mobilize and in some cases solubilize hydrocarbons into the aqueous phase. The aqueous viscoelastic solution or later-in-time treatments can recover mobilized hydrocarbons. The aqueous viscoelastic solution is operable to transport the formed hydrocarbon-surfactant emulsion as a physical sweeping fluid.

Introduction of hydrocarbons into the well bore after introduction of the aqueous viscoelastic solution, including introduction of a hydrocarbon-based gas such as methane, ethane, propane or natural gas, can cause the highly viscous aqueous viscoelastic solution to on again become mobile with a water-like consistency, permitting recovery or clean out of the treatment fluid.

The electrolyte content of the aqueous viscoelastic solutions influences the level of viscoelasticity of the aqueous viscoelastic solutions. The presence of positive ions, especially alkaline earth divalent ions, which include ions of calcium and magnesium, causes the viscoelastic surfactants to become more viscous when not in contact with a hydrocarbon than without the ions. With certain viscoelastic surfactants, the aqueous viscoelastic solution can form a gel-like material when not in contact with hydrocarbons. Although not intending to be bound by theory, it is believed that the disassociated ions interfere with the electrostatic repulsive forces of the charged hydrophilic groups of the viscoelastic surfactants. Normally, similarly charged molecules repel one another; however, the dissolved salt interferes with the repulsion process, allowing the hydrophobic portions of the viscoelastic surfactants to group closely together and form micelles. This close grouping results in greatly increased viscosity when hydrocarbons are not present, permitting fluids with lower viscosity to flow around the higher-viscosity material.

### Modified of Using the Aqueous Viscoelastic Solution for Water Alternating Gas Method

The modified WAG method uses an embodiment of the aqueous viscoelastic solution. The method is useful in non-primary forms of recovery from the hydrocarbon-bearing formation. The method is useful in a hydrocarbon-bearing heterogeneous formation, especially one having stratum of varying permeability. An embodiment of the method includes using the method in the heterogeneous formation having a ratio of permeability between high permeability stratum and low permeability stratum in a range of from about 7:1 to about 8:1.

The hydrocarbon-bearing formation is accessible through the separate injection well and the extraction well. The injection well acts as the fluid conduit for both the service gas and the aqueous viscoelastic solution to the hydrocarbon-bearing formation. The extraction well produces production fluid, which is the fluid emanating from the formation due to treatment. The portion of the formation between the injection well and the extraction well is treated using the modified WAG method. Treatment often includes multiple injection and extraction wells to improve coverage.

The modified water alternating gas (WAG) method includes introducing an embodiment of the previously described aqueous viscoelastic solution into the hydrocarbon-bearing formation. An embodiment of the method includes where the aqueous viscoelastic solution includes calcium chloride.

Upon introduction into the hydrocarbon-bearing formation, the aqueous viscoelastic solutions acts to plug areas of the formation lacking hydrocarbons and prevent further fluid flow through that area. Where pores and channels are clean and water-wet, the aqueous viscoelastic solution in the area retains its greater-than-water viscosity by forming micelles. The aqueous viscoelastic solution in such cleaned parts of the formation acts as a viscous fluid plug that is operable to direct other treatments fluids away from the cleaned areas, including directing other aqueous viscoelastic solution and service gas away from the treated area. In areas of the formation with hydrocarbons, the aqueous viscoelastic solution acts as a mobile aqueous solution with hydrocarbon-interactive surfactants useful for treating and emulsifying hydrocarbons. Fluid movement of the base aqueous solution conveys the hydrocarbons released from the formation towards the extraction point.

The localized reduction in fluid viscosity creates areas and channels susceptible to fluid mobility where hydrocarbons are present surrounded by areas of non-fluid mobility where hydrocarbons are not present. Differences in fluid viscosity directs not only additional aqueous viscoelastic solution and other treatment fluids to areas of the formation where hydrocarbons persist but also directs sweeping fluids into the areas where hydrocarbons are present to physical movement of the fluid.

The amount of aqueous viscoelastic solution introduced can vary depending upon operational need. An embodiment of the method includes introducing an amount of aqueous viscoelastic solution of about 20% of the estimated pore volume of the hydrocarbon-bearing formation to be treated. One of ordinary skill in the art is capable of estimating the pore volume of the formation for treatment. An embodiment of the method includes introducing aqueous viscoelastic solution until the production fluid produced is substantially free of hydrocarbons, indicating that the amount of aqueous viscoelastic solution applied has reached saturation within the formation.

The modified WAG method includes introducing a service gas into the hydrocarbon-bearing formation. The service gas interacts with hydrocarbons trapped in crevices and pores in the formation such that the hydrocarbons become mobile and recoverable. Service gas not entering the pores and crevices and dissolving the hydrocarbons acts to sweep the mobilized hydrocarbon towards the extraction well. An embodiment of the method includes introducing the service gas in a supercritical fluid state.

An embodiment of the method includes where the service gas is carbon dioxide. Carbon dioxide is soluble in hydrocarbons, especially crude oil, at the conditions present in the hydrocarbon-bearing formation. Carbon dioxide solubility in crude oil increases with carbon dioxide concentration and pressure. Carbon dioxide is relatively inexpensive and highly available. Near the point of miscibility, low interfacial tension and relative increase in volume of swollen crude oil drives it towards areas of lower pressure, including a point of extraction. When the pressure in the formation reaches minimum miscibility pressure, carbon dioxide acts as a solvent for crude oil chemically removing it from pores where physical removal is ineffective.

The amount of service gas introduced can vary depending upon operational need. An embodiment of the method includes introducing an amount of service gas of about 20% of the estimated pore volume of the hydrocarbon-bearing formation to be treated. An embodiment of the method includes introducing the service gas until the production fluid produced is substantially free of hydrocarbons, indicating that the amount of service gas applied has reached a saturation level in the formation.

Introduction of the aqueous viscoelastic solution and the service gas occurs sequentially and separately into the hydrocarbon-bearing formation. Either of the treatment fluids can be introduced first (service gas then aqueous viscoelastic solution or aqueous viscoelastic solution followed by service gas); however, the modified WAG method then alternates their introduction such that a first introduction follows a second introduction sequentially. The introduction does not occur simultaneously as simultaneous introduction would hinder the positive directing attributes of the aqueous viscoelastic solution for both the service gas and additional aqueous viscoelastic solution. An embodiment of the method includes introducing similar volumes of aqueous viscoelastic solution and service gas.

The injection rate into the hydrocarbon-bearing formation is such that neither the aqueous viscoelastic solution nor the service gas fractures or disrupts the overall physical structure of the hydrocarbon-bearing formation.

The introduction of each fluid (that is, aqueous viscoelastic solution and service gas) into the hydrocarbon-bearing formation causes the formation to produce the production fluid. The introduction of pressurized, non-compressible fluids causes fluids in the saturated, hydrocarbon-bearing formation to move through the formation from the point of introduction to the point of extraction. The production fluid contains hydrocarbons released or removed from the hydrocarbon-bearing formation by the WAG method. The production fluid also contains water. Some of the water comes from the hydrocarbon-bearing formation itself, a co-product of the production of hydrocarbons. The water also comes from prior introduction of sweeping fluids, including brines, sea water and fresh water from secondary recovery efforts. The water can also come from the introduction of the aqueous viscoelastic solution.

An embodiment of the method includes introducing aqueous viscoelastic solution until the production fluid produced during the aqueous viscoelastic solution introduction is substantially free of hydrocarbons by volume. An embodiment of the method includes introducing service gas until the production fluid produced during the service gas introduction is substantially free of hydrocarbons by volume. Production fluid substantially free of hydrocarbons indicates an effective technical limit of a singular removal treatment by either the aqueous viscoelastic solution or the service gas. Alternating to the other treatment fluid to take advantage of the change in chemical or physical properties of the hydrocarbons can extract additional amounts of hydrocarbons. An embodiment of the method includes repeating the alternating sequence of separate introduction of aqueous viscoelastic solution and introduction of the service gas until the production fluid produced is substantially free of hydrocarbons by volume. At a certain point, additional cycles will no longer produce effective amounts of hydrocarbons to justify the expense of continuing the procedure.

Optionally, the modified WAG method can include introduction of other treatment fluids after introducing the aqueous viscoelastic solution and the service gas to further encourage hydrocarbon production. An embodiment of the method includes introduction of a second service gas, which is different in composition from the service gas initially introduced, after introducing the aqueous viscoelastic solution and the service gas into the hydrocarbon-bearing formation. An embodiment of the method includes introduction of a second aqueous viscoelastic solution, which is different in composition from the aqueous viscoelastic solution initially introduced, after introducing the aqueous viscoelastic solution and the service gas into the formation.

For a hydrocarbon-bearing heterogeneous formation, a method for producing hydrocarbons from the heterogeneous formation includes the steps of introducing a sweeping fluid, introducing an aqueous viscoelastic solution and introducing a service gas separately into the formation. The sweeping fluid is introduced before either the aqueous viscoelastic solution or the service gas. Each fluid is introduced separately and sequentially to not counteract the full physical and chemical benefits of each fluid's introduction. The production fluid produced from each introduction contains both sweeping fluid and hydrocarbons. Useful sweeping fluids for removing already-mobile hydrocarbons from the heterogeneous formation include liquids such as sea water, brines, and fresh water. Natural gas is also useful as a sweeping fluid. The introduction of carbon dioxide as a sweeping fluid can occur as a gas, a liquid or a supercritical fluid.

An embodiment of the method includes introducing a second sweeping fluid, which is different from the sweeping fluid initially introduced, into the hydrocarbon-bearing heterogeneous formation. Introduction of the second sweeping fluid occurs after the introduction of all the other fluids. This second sweeping fluid is useful in potentially removing or counteracting some of the viscoelastic behavior of the aqueous viscoelastic solution remaining in the formation, permitting recovery of at least a portion of the fluid for reuse and hydrocarbon extraction from the removed aqueous viscoelastic fluid. The second sweeping fluid can include steam.

### EXAMPLES

Examples of specific embodiments and methods of their use facilitate a better understanding of the aqueous viscoelastic solution and modified WAG method. In no way do the Examples limit or define the scope of the invention.

A parallel core plug flooding system having two core plugs, each with a different permeability, is useful to simulate a heterogeneous hydrocarbon-bearing reservoir for showing the effect of the modified WAG process over a traditional WAG process.

The two core plugs have different permeability values, which represent a low permeability stratum and a high permeability stratum in a single hydrocarbon-bearing formation. The different core plugs have the properties given in Table 1:

TABLE 1
Physical properties of two core samples for use in
Example 1 and Comparative Example 1 demonstration.

| Core sample | Permeability, mD | Porosity, % | PV, cc |
|---|---|---|---|
| 1 | 45 | 25 | 12 |
| 2 | 5.8 | 16 | 5 |

Permeability is in units of millidarcys (mD), which is 10⁻¹² m². “PV” is the determined pore volume of each core sample in cubic centimeters (cc). The two cores samples have a permeability ratio (high permeability to low permeability) of about 7.75:1.

For both the Comparative Example and Example test methods, saturated core plug loads into a retaining chamber in the parallel core plug flooding system. Different materials saturate the two core plugs. Water saturates the more permeable core plug (core #1). “Dead” oil saturates the “tighter”, less permeable core plug (core #2). Each core plug saturates at 3,000 pounds per square inch gauge (psig) to ensure penetration of the fluids into the sample cores.

After saturation, the parallel core plug system pressure reduces to 2,000 psi while opening the test fluid introduction pathways and backpressure regulators. An oven heats the entire parallel core plug system pressure to a testing temperature of 75° F.

For both the Comparative Example and Example test methods, the two core plugs in parallel undergo simulated water flooding. The testing process includes introducing water into the parallel core plug systems such that water floods both core #1 and #2 simultaneously at a constant flow rate of 2 cc/min (cubic centimeters per minute). The introduction of flooding water produces to the parallel cores an amount of oil. Water flooding continues for several times the pore volume until the water content in the outlet of the parallel core plug system reaches about 99 vol. % of the collected material.

For the Comparative Example method, a simulated normal WAG process occurs after completion of the simulated water flooding. The simulated normal WAG process includes injecting about 0.2 pore volumes (PVs) of carbon dioxide into the parallel core plug system at a constant injection rate of about 2 cc/min at about 2,000 psig, then injecting about 0.2 pore volumes of water at the same fluid flow rate at about the same pressure. The simulated normal WAG process repeats for several total pore volumes until the water content in the outlet of the parallel core plug system reaches about 99 vol. % of the collected material.

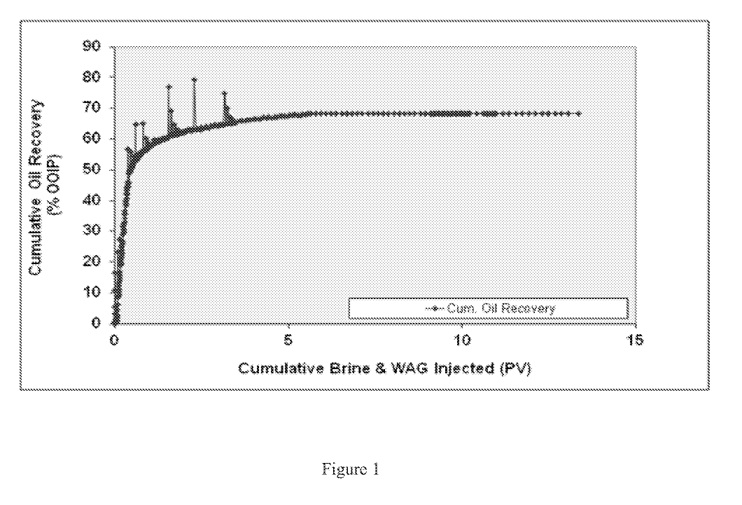

FIG. 1 shows graphically the results of the Comparative Example method on the set of tandem core samples. The Comparative Example WAG process recovers no appreciable amount of oil from the parallel core plug system using equal parts carbon dioxide and water. Although not intending to be bound by theory, it is believed that the flow of the carbon dioxide and water divert into the water-saturated, high-permeability core such that no additional oil is obtained from the tighter “dead” oil soaked core. The low-permeability core retains a significant portion of the OOIP.

For the Example method, a simulated modified WAG process occurs after completion of the simulated water flooding. The simulated modified WAG process includes injecting about 0.2 PVs of carbon dioxide into the parallel core plug system at a constant injection rate of about 2 cc/min at about 2,000 psig, then injecting about 0.2 PVs of aqueous viscoelastic solution at the same fluid flow rate at about the same pressure. The aqueous viscoelastic solution includes about 6 weight percent (wt. %) viscoelastic surfactant and about 3 wt. % of calcium chloride. The remainder of the aqueous viscoelastic solution is water. The pH of the aqueous viscoelastic solution is about 7. The modified WAG process repeats for a total of several pore volumes until the water content in the outlet of the parallel core plug system reaches about 99 vol. % of the collected material.

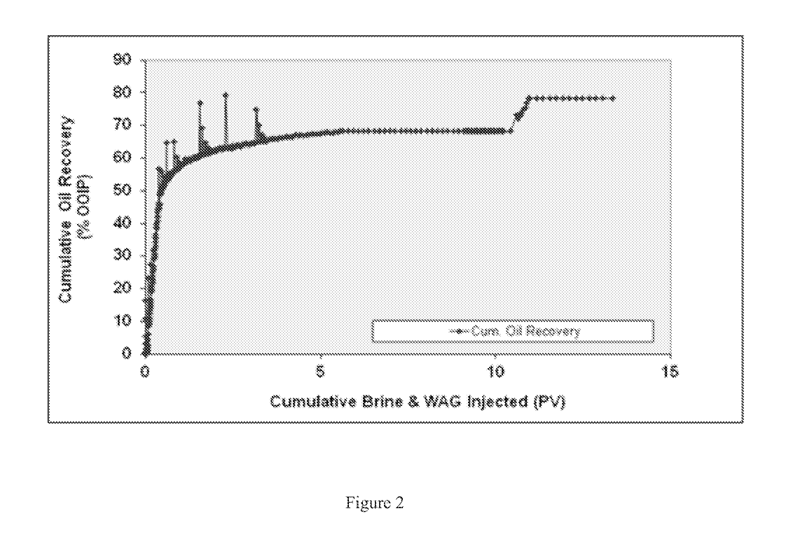

FIG. 2 shows graphically the results of the Example method on the set of tandem core samples. The simulated modified WAG process recovers an additional 10 vol. % more oil from the set of tandem cores using the alternating combination of equal parts carbon dioxide and aqueous viscoelastic solution. Although not intending to be bound by theory, it is believed that the ionized and surfactant-bearing aqueous viscoelastic solution present in the more permeable core plug (core #1) diverts a significant portion of the introduced carbon dioxide and aqueous viscoelastic solution into the tighter, oil-bearing core plug (#2). Through both chemical affects and transport phenomenon, the “tighter” core plug upon direct exposure to the separately introduced carbon dioxide and aqueous viscoelastic solution yields a portion of the “dead” oil not received through the Comparative Example method.

What is claimed is:

1. A modified water alternating gas (WAG) method for producing hydrocarbons from a hydrocarbon-bearing formation, the modified WAG method comprising the steps of:
introducing an aqueous viscoelastic solution into the hydrocarbon-bearing formation, and
introducing a service gas into the hydrocarbon-bearing formation,
where the aqueous viscoelastic solution and the service gas are introduced separately and sequentially into the hydrocarbon-bearing formation such that the hydrocarbon-bearing formation produces a production fluid, the production fluid containing both water and hydrocarbons, in response to each introduction.

2. The method of claim 1 where the hydrocarbon-bearing formation is heterogeneous having a high permeability stratum and a low permeability stratum, and a ratio of permeability between the high permeability stratum and the low permeability stratum in a range of from about 7:1 to about 8:1.

3. The method of claim 1 where the service gas comprises carbon dioxide.

4. The method of claim 1 where the service gas is introduced as a supercritical fluid.

5. The method of claim 1 where the aqueous viscoelastic fluid comprises calcium chloride.

6. The method of claim 1 where an amount of the aqueous viscoelastic solution introduced during the introducing the aqueous viscoelastic solution step and an amount of service gas introduced in the introducing the service gas step are similar in volume.

7. The method of claim 1 where an amount of the aqueous viscoelastic solution introduced during the introducing the aqueous viscoelastic solution step is about 20% of an estimated pore volume of the hydrocarbon-bearing formation to be treated.

8. The method of claim 1 where an amount of the service gas introduced during the introducing the service gas step is about 20% of an estimated pore volume of the hydrocarbon-bearing formation to be treated.

9. The method of claim 1 where the aqueous viscoelastic solution is introduced until the production fluid produced during the step is substantially free of hydrocarbons by volume and where the service gas is introduced until the production fluid produced during the step is substantially free of hydrocarbons by volume.

10. The method of claim 1 further comprising the step of repeating the alternating sequence of separate introductions of the aqueous viscoelastic solution and the service gas until the production fluid produced is substantially free of hydrocarbons by volume, where the step of repeating occurs after the steps of introduction of the aqueous viscoelastic solution and introduction of the service gas.

11. The method of claim 1 further comprising the step of introducing a second service gas into the hydrocarbon-bearing formation, where the step of introduction of the second service gas occurs after the steps of introduction of the aqueous viscoelastic solution and introduction of the service gas, and where the second service gas is different from the service gas initially introduced.

12. The method of claim 1 further comprising the step of introducing a second aqueous viscoelastic solution into the hydrocarbon-bearing formation where the step of introduction of the second aqueous viscoelastic solution occurs after the steps of introduction of the aqueous viscoelastic solution and introduction of the service gas, where the second aqueous viscoelastic solution is different from the aqueous viscoelastic solution initially introduced.

13. A method for producing hydrocarbons from a hydrocarbon-bearing heterogeneous formation, the method for producing hydrocarbons comprising the steps of:
introducing a sweeping fluid into the hydrocarbon-bearing heterogeneous formation;
introducing an aqueous viscoelastic solution into the heterogeneous formation; and
introducing a service gas into the heterogeneous formation;
where the hydrocarbon-bearing heterogeneous formation includes a low permeability stratum and a high permeability stratum;
where the sweeping fluid is introduced before the aqueous viscoelastic solution and the service gas; and
where the sweeping fluid, the aqueous viscoelastic solution and the service gas are each introduced separately and sequentially into the hydrocarbon-bearing heterogeneous formation such that the hydrocarbon-bearing heterogeneous formation produces a production fluid, the production fluid containing both the sweeping fluid and hydrocarbons in response to each introduction.

14. The method of claim 13 where the sweeping fluid is selected from a group consisting of sea water, brines, fresh water, natural gas, carbon dioxide and combinations thereof.

15. The method of claim 13 where the sweeping fluid, the aqueous viscoelastic solution and the service gas are introduced during each step, respectively, until the production fluid produced during each step is substantially free of hydrocarbons by volume.

16. The method of claim 13 further comprising the step of introducing a second sweeping fluid into the hydrocarbon-bearing heterogeneous formation, the introducing a second sweeping fluid step occurring after the steps of introducing the sweeping fluid, the aqueous viscoelastic solution and the service gas, respectively, and the second sweeping fluid different from the sweeping fluid introduced.

17. The method of claim 16 where the second sweeping fluid is steam.

18. An aqueous viscoelastic solution composition useful in a modified water alternating gas (WAG) hydrocarbon recovery method, the aqueous viscoelastic solution composition comprising:
a viscoelastic surfactant in range of from about 0.1% to about 6% of the total weight of the aqueous viscoelastic solution,
a salt in a range of from about 1% to about 10% of the total weight of the aqueous viscoelastic solution, and
a base aqueous solution in a range of from about 84% to about 98.9% of the total weight of the aqueous viscoelastic solution.

19. The aqueous viscoelastic solution of claim 18 where the viscoelastic surfactant is selected from a group consisting of non-ionic viscoelastic surfactants, anionic viscoelastic surfactants, cationic viscoelastic surfactants and combinations thereof.

20. The aqueous viscoelastic solution of claim 18 where the salt is selected from a group consisting of inorganic salts, organic salts and combinations thereof.

21. The aqueous viscoelastic solution of claim 20 where the salt comprises calcium chloride.
